(19) United States
(12) Patent Application Publication
(10) Pub. No.: US 2022/0319079 A1
(43) Pub. Date: Oct. 6, 2022

(54) CONTENT CREATION SUPPORT SYSTEM, SERVER, TERMINAL, METHOD FOR SUPPORTING CONTENT CREATION, AND STORAGE MEDIUM

(71) Applicant: DAI NIPPON PRINTING CO., LTD., Tokyo (JP)

(72) Inventor: Yu TAKAHASHI, Tokyo (JP)

(73) Assignee: DAI NIPPON PRINTING CO., LTD., Tokyo (JP)

(21) Appl. No.: 17/700,690

(22) Filed: Mar. 22, 2022

(30) Foreign Application Priority Data
Mar. 30, 2021 (JP) 2021-057667

(51) Int. Cl. G06T 11/60; G06T 1/00; G06F 16/957; G06F 16/50; G06F 16/70; G06F 21/62

(52) U.S. Cl. CPC G06T 11/60; G06T 1/0007; G06F 16/9574; G06F 16/50; G06F 16/70; G06F 21/6272

(57) ABSTRACT

A content creation support system that can provide various contents and allows a creator to use the contents without anxiety to create a work is provided. The content creation support system includes a photographing system that is provided at a theme park and takes images of visitors to the theme park, a server that acquires the image (a park image) taken by the photographing system, and a creator's terminal that is communicatively connectable to the server via a network. A content providing unit of the server provides to the creator's terminal the park image and official contents as editable contents, which are combined with a creator's content created by the creator to create a work.

### TECHNICAL FIELD

The present invention relates to a content creation support system, a server, a terminal, a method for supporting content creation, and a storage medium, and more particularly to a system that supports creation of video contents etc.

### BACKGROUND

There has been a service for taking pictures of visitors visiting theme parks such as an amusement park, and selling the picture or image data to the visitor as a souvenir (see Patent Document 1, for example). Such kind of service often provides to the visitor, when selling the image data, a download ticket attached with a QR code (a registered trademark) for accessing a download site of the image.

In addition, with wide spread of social networking services (SNS) and video sharing websites, users of such platforms can easily upload and publicly share their creations including pictures and videos. This trend has lead to a spread of new types of entertainment, such as attracting people's attention by creating better works or supporting creators by following and watching their creations.

### RELATED ART

[Patent Document 1] Japanese Unexamined Patent Application Publication No. 2004-228637 (JP-A-2004-228637)

### SUMMARY

### Problems to be Solved by the Invention

However, to publicize images taken in the theme park etc. on SNS or the like, it is necessary to obtain a license at each time, and this has been imposing a burden on both the licenser and the user. Also, contents that can be purchased at the spot (inside the theme park) are conventionally limited mainly to photographs.

The present invention is made in view of the above problems, and it is an object of the present invention to provide a content creation support system and the like that can provide various contents and allows a creator to use the contents without anxiety to create a work.

### Means for Solving Problems

To achieve the above object, a first aspect of the present invention is a content creation support system including a photographing system that is provided at a spot and takes an image or a video of a visitor to the spot, a server that acquires a taken image, which is either the image or the video taken by the photographing system, and a creator's terminal that is used by a creator and is communicatively connectable to the server via a network. The server includes a content providing unit that provides, to the creator's terminal, the taken image and officially prepared official contents as editable contents, which are combined with a creator's content created by the creator to create a work.

In the present invention, the spot refers to a place where people actually visit. Examples of the spot are theme parks, such as amusement parks and amusement facilities, venues for events and exhibitions, wedding halls, and schools.

According to the first aspect of the present invention, the server acquires the taken image taken by the photographing system at the spot such as a theme park, and provides the taken image and the official contents as editable contents, which are combined with the creator's content created on the creator's terminal. Thus, in addition to photographs that can be obtained on-site, it is also possible to provide various contents such as image materials and sound materials. The present invention also allows the creator to use such contents without anxiety to create a work.

In the first aspect of the present invention, the server provides via a web site to the creator's terminal editing means configured to create the work using the taken image, the official contents, and the creator's content. This enables the creator to edit the work via the web site. This makes it easy for a manager to manage the taken images of the photographing system 2 and the official contents, and for the creator to use without anxiety park images or the official contents as licensed contents.

Alternatively, the content providing unit may provide the taken image and the official contents to be editable on the creator's terminal, and the creator's terminal may include an editing process unit for creating the work using the taken image, the official contents, and the creator's content. In this way, the editing can be done on the creator's terminal, and thus editing operations can be carried out even when a network environment is not always available.

The server includes a registration unit that registers the creator. The content providing unit provides the taken image and the official contents only to the creator who has been registered by the registration unit. The server may also include a setting unit for setting a rank of the creator so that the usable official contents provided by the content providing unit may differ depending on the rank of the creator set by the setting unit. In this way, the taken image or the official contents are provided only to the authorized creators, and this can prevent illegal use of the contents. Also, the rank of the creator is set according to criteria such as the number of views of videos or years of experience and the contents are provided according to the rank. This hopefully motivates the creator more and improves quality of the work.

Also, the content providing unit preferably provides the official contents that are suitable for the provided taken image. In an attempt to provide various types of contents, the official contents that are suitable for the date on which the taken image is taken may be provided, for example.

Preferably, the server further includes a publicizing unit for publicizing the work. An advertising effect for the theme park can be expected by publicizing the content created by the creator. For the creator, the creator may be able to gain viewers who have interests in the theme park.

The server may further include a checking unit to check whether the work can be publicized or not. The publicizing unit preferably publicizes the work only when the checking unit decides that the work can be publicized. For example, the publicizing unit publicizes the work after the checking unit checks if the work properly includes the taken image, or if the work is suitable to be publicized.

The server preferably includes an image managing unit that acquires the purchased taken image from the photographing system and manages use for the work and storage time of the taken image. This makes it possible to acquire only the purchased taken image from the photographing system, provide the taken image to the creator's terminal of the purchaser, and delete the taken image of which the storage time has expired, for example, to manage the images and storage appropriately.

A second aspect of the present invention is a server including an image acquisition unit, a communication unit, and a content providing unit. The image acquisition unit acquires a taken image, which is either an image or a video, taken by a photographing system that is provided at a spot and takes the taken image of a visitor to the spot. The communication unit communicatively connects via a network to a creator's terminal, which is a terminal used by a creator. The content providing unit provides to the creator's terminal the taken image and officially prepared official contents as editable contents, which are combined with a creator's content created by the creator to create a work.

The second aspect of the present invention can provide the server for the content creation support system according to the first aspect of the present invention.

A third aspect of the present invention is a terminal that is communicatively connectable via a network to a server for acquiring a taken image, which is either an image or a video, taken by a photographing system that is provided at a spot and takes the taken image of a visitor to the spot. The terminal includes a download unit and an editing process unit. The download unit downloads from the server the taken image and officially prepared official contents. The editing unit edits and creates a work by combining the downloaded taken image and the official contents with creator's content, which is a content created by a creator.

The third aspect of the present invention can provide the creator's terminal for the content creation support system according to the first aspect of the present invention.

A fourth aspect of the present invention is a method for supporting content creation. The method includes the steps of taking an image or a video by a photographing system that is provided at a spot and takes images of visitors to the spot, acquiring through a server a taken image, which is either a picture or a video taken by the photographing system, providing through the server the editable taken image and officially prepared official contents to a terminal that is communicatively connected via a network to the server, and editing a work by a creator using the terminal and combining the taken image and the official contents with creator's content, which is a content created by the creator.

According to the fourth aspect of the present invention, the server acquires the taken image taken by the photographing system, and provides the taken image and the official contents as editable contents, which are combined with the creator's content created on the creator's terminal to create a work. The creator uses the terminal and combines the taken image, the official contents, and the creator's content to edit the work. In this way, various official contents including image materials and sound materials in addition to photographs can be provided online, and the creator can use such the contents without anxiety to create the work.

A fifth aspect of the present invention is a storage medium that stores a program that causes a computer to function as an image acquisition unit, a communication unit, and a content providing unit. The image acquisition unit acquires a taken image, which is either an image or a video, taken by a photographing system that is provided at a spot and takes images of visitors to the spot. The communication unit communicatively connects via a network to a creator's terminal, which is a terminal used by a creator. The content providing unit provides to the creator's terminal the taken image and officially prepared official contents as editable contents, which are combined with a creator's content created by the creator to create a work.

The fifth aspect of the invention can cause a computer to function as the server for the content creation support system according to the first aspect of the present invention, or the server for the second aspect of the present invention.

A sixth aspect of the present invention is a storage medium that stores a program that causes a computer, which is communicatively connectable via a network to a server, to function as a download unit and an editing process unit. The download unit downloads from the server a taken image taken by a photographing system that is provided at a spot and takes images of visitors to the spot and officially prepared official contents. The editing unit edits and creates a work by combining the downloaded taken image and the official contents with creator's content, which is a content created by a creator.

The sixth aspect of the invention can cause a computer to function as the creator's terminal for the content creation support system according to the first aspect of the present invention, or the terminal for the third aspect of the present invention.

### Effects of the Invention

The present invention can provide a content creation support system and the like that can provide various contents and allows a creator to use the contents without anxiety to create a work.

### BRIEF DESCRIPTION OF THE DRAWINGS

FIG. 1 is a view showing an overall configuration of a content creation support system 1.

FIG. 2 is a view showing a configuration of a ticket issuing device 22 of a photographing system 2.

FIG. 3 is a view showing a data configuration of a taken image data 20 taken by the photographing system 2.

FIG. 4 is a view showing an example of a download ticket 82 (a printed matter 8).

FIG. 5 is a view showing a hardware configuration of a server 3.

FIG. 6 is a view showing a hardware configuration of a creator's terminal 4.

FIG. 7 is a view showing a functional configuration of the server 3 and the creator's terminal 4.

FIG. 8 is a view illustrating a work 50.

FIG. 9 is a flowchart showing a flow of a registration process of a new user.

FIG. 10 is a view showing a data configuration of user information 323.

FIG. 11 is a flowchart showing a flow of a download ticket issuing process.

FIG. 12 is a view showing a data configuration of park image data 321, which is an image acquired from the photographing system 2.

FIG. 13 is a flowchart showing a flow of an image managing process.

FIG. 14 is a flowchart showing a flow of an editing process via a web site (a web application).

FIG. 15 is a view showing a data configuration of an official content data 322 stored in the server 3.

FIG. 16 is a view showing an example of an editing screen 70.

FIG. 17 is a flowchart showing a flow of a publicizing process.

FIG. 18 is a view showing a functional configuration of a server 3A and a creator's terminal 4A according to a second embodiment.

FIG. 19 is a flowchart showing a flow of an editing process using an editing application 42 of the creator's terminal 4A.

### DETAILED DESCRIPTION

Hereinafter, preferable embodiments of the present invention will be described with reference to the accompanying drawings. The embodiments will be described referring to an example in which the present invention is applied in a photographing system 2 that takes and sells images of visitors visiting a theme park, etc. However, the present invention is not limited to such examples, and can be applied to various photographing services having the above-mentioned problems.

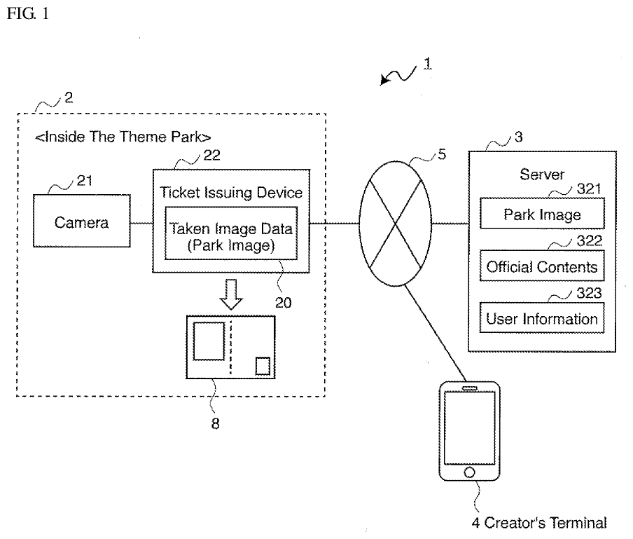

FIG. 1 is a view showing an overall configuration of a content creation support system 1 of the present invention. The content creation support system 1 includes the photographing system 2, a server 3, and a creator's terminal 4, which are communicatively connected to each other via a network 5.

The photographing system 2 includes a camera 21 that is installed in a theme park, for example, and a ticket issuing device 22 that issues a download ticket 82.

The camera 21 is a digital camera that takes images of visitors. The camera 21 is a camera used by a photographing staff (or a cameraman), or is installed on an attraction (e.g., a roller coaster) provided in the theme park. After taking an image, the camera 21 issues a photograph ID 20a, which is identification information of the image, and sends a taken image 20b (a photograph or a video) and the photograph ID 20a to the ticket issuing device 22. The taken image 20b and the photograph ID 20a are stored as taken image data 20 in a memory unit 202 or a storage 100 of the ticket issuing device 22. The camera 21 and the ticket issuing device 22 are communicatively connected either by wire or wirelessly.

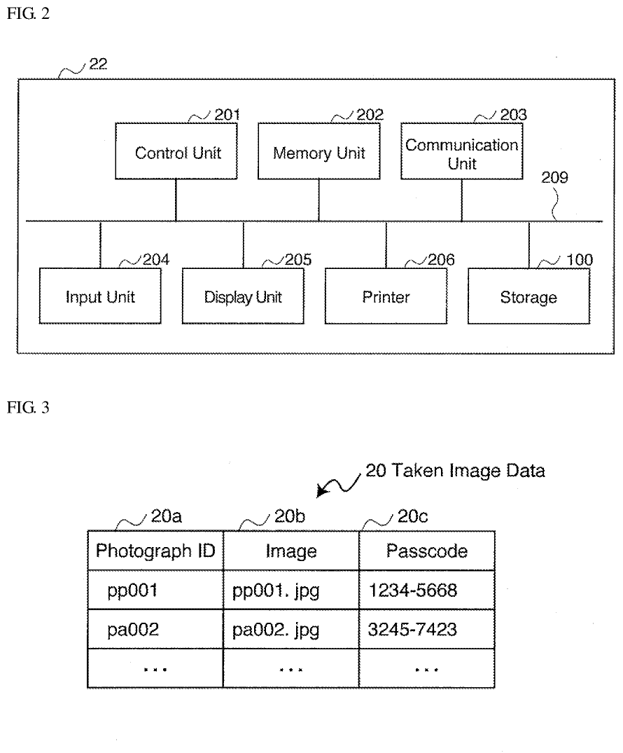

The ticket issuing device 22 is a device for issuing the download ticket 82 that is used by a user to download the image 20b. The download ticket 82 will be described in detail below. FIG. 2 is a view showing an example of a hardware configuration of the ticket issuing device 22. As shown in FIG. 2, the ticket issuing device 22 includes a control unit 201, the memory unit 202, a communication unit 203, an input unit 204, a display unit 205, a printer 206, the storage 100, a bus 209, and so on.

The control unit 201 includes a central processing unit (CPU), a read only memory (ROM), a random access memory (RAM), and so on. The CPU reads out a program stored in the memory unit 202, the ROM, storage media, or the like to a work memory region on the RAM, executes the program, and drives and controls each device connected via the bus 209 to achieve a ticket issuing process performed by the ticket issuing device 22.

The memory unit 202 is a flash memory, a hard disk drive (HDD), or the like, and stores programs executed by the control unit 201, as well as data necessary for execution of the programs, the operating system (OS), and so on. The programs include a control program that is equivalent to the OS and an application program that causes the ticket issuing device 22 to execute a process of issuing the download ticket 82. Such program codes are read out by the control unit 201 as necessary, moved to the RAM, read out by the CPU, and executed to perform various tasks.

The display unit 205 is achieved by a touch panel display or the like that also functions as an input unit for the ticket issuing device 22. The display unit 205 displays various screens pertaining to user's operations and selections, and receives user's instruction inputs etc. through touch operations on the screen. The input unit 204 includes the above touch panel and various buttons etc., and inputs input signals into the control unit 201.

The communication unit 203 includes a communication control device, a communication port, and so on. The communication unit 203 is a communication interface that mediates communication between the ticket issuing device 22 and the network 5, and can perform communication control between the storage 100 and other computers via the network 5. The network 5 may be either wired or wireless. The bus 209 is a path that mediates transmission and reception of control signals and data signals between the devices.

The printer 206 prints on a predetermined paper a two-dimensional code 88 (e.g., a QR code (a registered trademark) or a bar code) that includes address information of the image 20b taken by the camera 21 and the server 3, and outputs the download ticket 82. The printer 206 is a high-resolution color printer, for example, and any type of printing method including a sublimation type or a melting type may be used.

The memory unit 202 or the storage 100 stores the image 20b (the taken image data 20) taken by the camera 21. The storage 100 may be an online storage that is accessible via the network 5 from the camera 21 and the ticket issuing device 22.

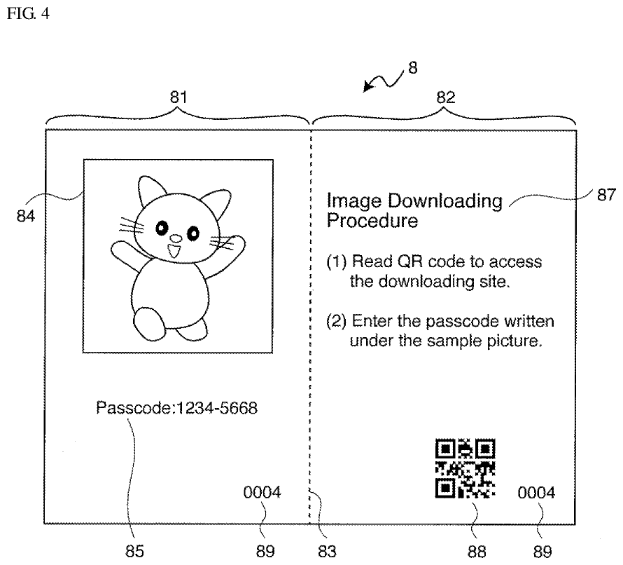

FIG. 3 is a view showing a content of the taken image data 20 stored in the memory unit 202 or the storage 100. The taken image data 20 includes the photograph ID 20a generated by the camera 21, the image 20b that is an image taken by the camera 21, and a passcode 20c, which are stored being linked with each other.

The photograph ID 20a is identification information that uniquely identifies the image 20b taken by the camera 21 and is issued by the camera 21 at each photo shoot. The image 20b is data of an image taken by the camera 21. The passcode 20c is an authorization code for the user to download the image 20b. The passcode 20c is issued every time the ticket issuing device 22 issues the download ticket 82. That is, the passcode 20c is issued for each image 20b.

FIG. 4 is a view showing an example of a printed matter 8 that is printed by the printer 206 of the ticket issuing device 22. As shown in FIG. 4, the printed matter 8 has a perforation 83 so as to be torn in two. With the perforation 83 as a border, a sample photo 84 is printed on a region 81 on one side of the border (a left side region in FIG. 4). The sample photo 84 is provided free of charge for sales promotion. The other region with the perforation 83 as the border (a right side region in FIG. 4) is to be the download ticket 82.

The sample photo 84 is a printed image of the image 20b taken by the camera 21, and information 85 is printed underneath the image 20b. The information 85 shows the passcode 20c, which is identification information for downloading the image 20b. On the download ticket 82, a writing 87 that describes a procedure for downloading the image 20b (a park image 321b) is printed. In addition, address information of the server 3 is also printed in a form of a two-dimensional code 88.

Although an example in which the download ticket 82 is printed out as the printed matter 8 (a paper medium) has been described above, an output form is not restricted to the paper medium. For example, the ticket issuing device 22 and the creator's terminal 4 may be communicatively connected using a short distance wireless communication function or the like of the communication unit 203, and the ticket issuing device 22 can output data including the sample photo 84, the passcode 85, and the address information of the server 3, which is equivalent to the printed matter 8. In such the case, there is no need to provide the printer 206 in the ticket issuing device 22.

Next, the server 3 will be described. The server 3 is a server that manages the park image data 321, official content data 322, and user information 323 in the content creation support system 1.

The park image data 321 is data for managing the image 20b (the park image 321b) taken by the camera 21 in the theme park, and is stored in the memory unit 302 of the server 3 when the image 20b purchased by a user (a creator) is uploaded from the photographing system 2 (the ticket issuing device 22) to the server 3.

The official content data 322 is data for managing contents, such as material images and material sounds, that are officially provided by a manager of the photographing system 2 or the server 3. The official content data 322 is stored in the memory unit 302.

The user information 323 is information of the user who has registered to use the content creation support system 1. A new user registration process registers the user information 323 in the memory unit 302 of the server 3.

The server 3 provides the park image 321b and official contents 322b to the registered creator, thereby allowing the creator to edit the park image 321b and official contents 322b. The server 3 also publicizes a work 50 created by the creator.

FIG. 5 is a view showing a hardware configuration of the server 3. As shown in FIG. 5, the server 3 can be achieved by a computer including a control unit 301, a memory unit 302, a communication unit 303, and so on that are connected to each other via a bus 309 etc. However, other unlimited configurations may be appropriately chosen.

The control unit 301, the memory unit 302, and the communication unit 303 function approximately the same way as the above-mentioned control unit 201, the memory unit 202, and the communication unit 203. The memory unit 302 of the server 3 stores programs that cause the server 3 to execute an image managing process, the new user registration process, an editing process, and a publicizing process, which will be described below. The server 3 may be configured by a plurality of computers each of which having a different function. For example, the server 3 may be configured by, and share the processes with a plurality of computers, such as an image managing server, a user registration server, an editing server, and a publicizing server.

The creator's terminal 4 is a terminal, such as a smart phone, a personal computer, and a tablet, that is held by the creator who creates the work 50 in the present invention. In the present embodiment, the creator visits the theme park, obtains the download ticket 82 issued by the ticket issuing device 22 of the photographing system 2, and accesses the server 3 by reading the address information 88 (a two-dimensional code) printed on the download ticket 82 using a camera 406 etc. of the creator's terminal 4 so that the creator can purchase and edit the image 20b (the park image 321b) taken by the photographing system 2. Such the processes (the image managing process and the editing process) will be described below.

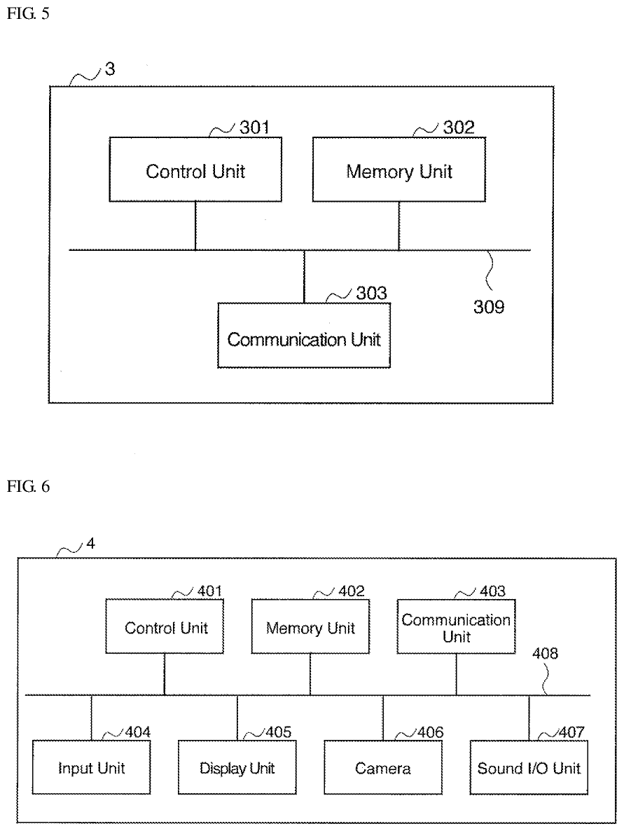

FIG. 6 is a view showing a hardware configuration of the creator's terminal 4. As shown in FIG. 6, the creator's terminal 4 include a control unit 401, a memory unit 402, a communication unit 403, an input unit 404, a display unit 405, the camera 406, a sound input/output (I/O) unit 407, and so on that are connected to each other via a bus 408 etc. However, other unlimited configurations may be appropriately chosen.

The control unit 401, the memory unit 402, the communication unit 403, and the input unit 404 function approximately the same way as the above-mentioned control unit 201, the memory unit 202, the communication unit 203, and the input unit 204. Also, the display unit 405 has a display device such as a liquid crystal panel, and a touch panel as the input unit 404 is provided. The sound I/O unit 407 includes a microphone and a speaker, etc.

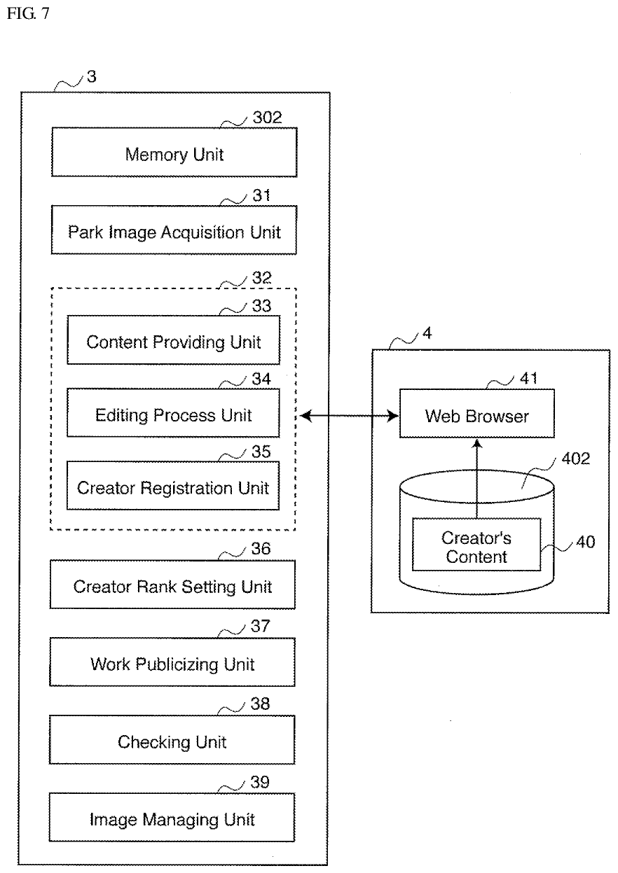

Next, a functional configuration of the server 3 and the creator's terminal 4 in the content creation support system 1 will be described referring to FIG. 7. As shown in FIG. 7, the server 3 is provided with the memory unit 302, a park image acquisition unit 31, a content providing unit 33, an editing process unit 34, a creator registration unit 35, a creator's rank setting unit 36, a work publicizing unit 37, a checking unit 38, an image managing unit 39, and so on. The content providing unit 33, the editing process unit 34, and the creator registration unit 35 are installed on the server 3 as a web application 32 in the first embodiment. The web application 32 executes processes of providing and editing the contents (the park image 321b and the official contents 322b) and registration of the creator (user registration) via a web site provided by the server 3.

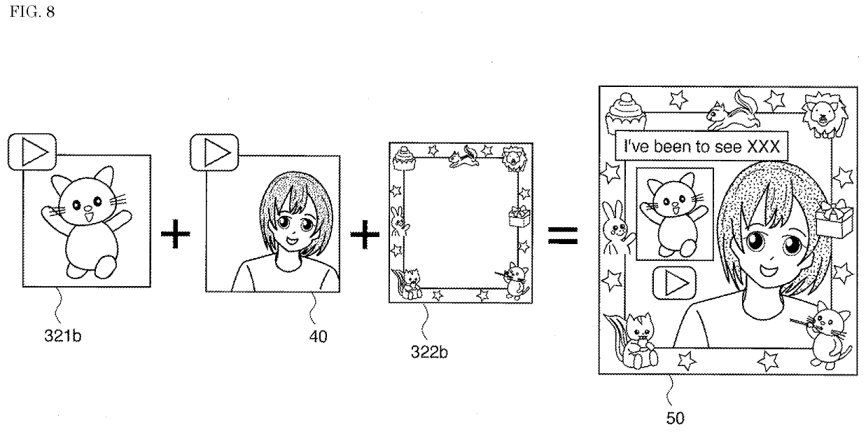

The creator's terminal 4 includes a web browser 41. By accessing the above-mentioned web site via the web browser 41, data can be transmitted and received between the creator's terminal 4 and the server 3 and the processes of providing and editing the contents (the park image 321b and the official contents 322b) and registration of the creator (user registration) can be executed. Also, the memory unit 402 of the creator's terminal 4 stores a creator's content 40. The creator's content 40 may be a content such as a video, an image, sound, etc. that is created by the creator. The creator can combine the park image 321b and the official contents 322b, which are provided by the server 3 via the above web site, with the creator's content 40 to create the work 50 (FIG. 8).

The memory unit 302 of the server 3 stores the park image data 321, the official content data 322, and the user information 323 as mentioned above.

The park image acquisition unit 31 acquires, among the images 20b, which are either images or videos taken by the photographing system 2, the image 20b purchased by a user. The acquired image 20b is then stored in the memory unit 302 as the park image 321b. The park image 321b is stored being linked to a user ID 321d (323a) of the user (creator) who purchased the image. Acquisition of the image 20b (the park image 321b) from the photographing system 2 will be described below.

The content providing unit 33 provides the park image 321b and the official contents 322b as editable contents to the predetermined creator's terminal 4. Since the contents are provided to the creator's terminal 4 online, not only photographs but also videos and sounds etc. can be provided. Also, the content providing unit 33 may provide the official contents 322b that are suitable for the provided park image 321b. For example, in an attempt to provide various types of contents, the content providing unit 33 may provide the official contents 322b that are suitable for the date on which the park image 321b is taken, or the official contents 322b that are related to a character or an attraction taken in the park image 321b.

The editing process unit 34 is an editing process unit for creating the work 50 by using the park image 321b, the official contents 322b, and the creator's content 40, in which an editing screen 70 or the like is provided to the creator's terminal 4 via the web site. By accessing the server 3 via the web browser 41, the creator's terminal 4 can perform the editing process using the editing screen 70.

The creator registration unit 35 authorizes and registers the user who satisfies predetermined criteria as the creator. The predetermined criteria may be the number of videos uploaded on video sharing sites or SNS, the number of viewers, the number of views, the year of experience, etc., for example. The content providing unit 33 permits providing of the park image 321b and the official contents 322b only to the creators who are registered by the creator registration unit 35.

The creator's rank setting unit 36 sets a rank of the creator. For example, the authorized creators may be ranked as ‘S’, ‘A’, or ‘B’ based on results of the authorization by the manager. It is also possible to make the content providing unit 33 provide the official contents 322b differently depending on the creator's rank. For example, the official contents 322b available only for the ‘S’ ranked creators and the official contents 322b available for the creators of any rank may be prepared.

The work publicizing unit 37 publicizes the work 50 created by the creator. The work 50 may be publicized on a publicizing web site that is exclusive for the content creation support system 1, or on common SNS or video sharing sites, etc.

The checking unit 38 checks whether the work 50 created by the creator can be publicized or not. For example, the checking unit 38 examines whether the work 50 includes the park image 321b or not, whether the work 50 is appropriate to be publicized or not, or whether the work 50 contains inappropriate contents or not, etc. to check if the work 50 can be publicized or not.

The image managing unit 39 acquires from the photographing system 2 the image 20b (the park image 321b) taken by the photographing system 2, manages a use of the park image 321b (providing to the creator's terminal 4), and manages storage time of the park image 321b stored in the memory unit 302.

Next, each process executed by the content creation support system 1 will be described.

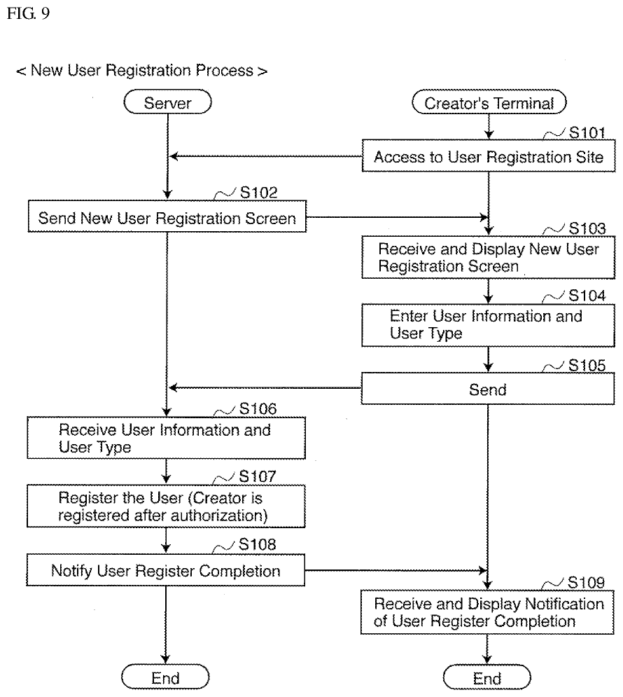

First, the new user registration process will be described referring to FIG. 9. When the creator wishes to be registered as a new user, the creator accesses to a user registration site of the server 3 via the web browser 41 of the creator's terminal 4 (a step S101). The control unit 301 of the server 3 (the creator registration unit 35) sends a new user registration screen to the creator's terminal 4 (a step 102). The creator's terminal 4 displays the new user registration screen on the display unit 405 (a step S103). The creator enters on the new user registration screen information concerning the user (name, password, e-mail address, etc.) and a preferred user type (a step S104). The user type may be either a ‘creator’ or a ‘normal user’, for example. If ‘creator’ is selected, authorization by the manager of the content creation support system 1 is required. Selection of ‘normal user’ requires no authorization, and anyone can be registered as the ‘normal user’. The control unit 401 of the creator's terminal 4 sends the entered user type and the user information to the server 3 (a step S105).

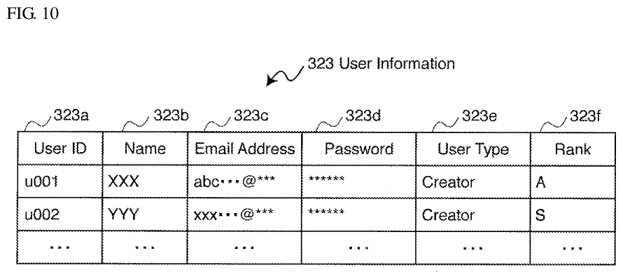

When receiving the user type and the user information (a step S106), the server 3 (the creator registration unit 35) issues the user ID 323a, which is then stored in the memory unit 302, making a link with the received user information and the user type (FIG. 10). The registration is completed here if the user type is ‘normal user’. If the user type is ‘creator’, the user is registered after the authorization by the manager checking whether the user can be registered as the creator or not (a step S107). If the authorization is denied, the user is registered as the ‘normal user’. The control unit 301 of the server 3 sends a notification of completion of the user registration to the registered e-mail address (the creator's terminal 4) (a step S108). The notification of completion of the user registration notifies a user ID, the user type, and a result of the authorization for the ‘creator’, etc. When receiving the notification of completion of the user registration, the creator's terminal 4 displays on the display unit 405 the received notification of completion of the user registration (a step S109).

FIG. 10 is a view showing a data configuration of the user information 323 to be registered in the server 3. As shown in FIG. 10, the user information 323 stores the user ID 323a, a name 323b, an e-mail address 323c, a password 323d, a user type 323e, and a rank 323f. The user ID 323a is issued by the control unit 301 of the server 3 at the time of the new user registration. The name 323b, the e-mail address 323c, and the password 323d are registered information sent from the creator's terminal 4. The user type 323e is set to be either ‘creator’ or ‘normal user’ according to the user's request or the result of the authorization. The rank 323f is set when the user type 323e is the ‘creator’, and the user is ranked as ‘S’, ‘A’, or ‘B’ based on the result of the authorization performed by the manager. For example, the rank 323f is set according to the number of uploaded videos, the number of views, the number of viewers, and the year of experience, etc.

Next, a process of taking an image of a visitor (an object) by the photographing system 2, sending the taken image to the ticket issuing device 22, and issuing the download ticket 82 (the ticket issuing process) will be described. In the present embodiment, the visitor (the creator) has been already registered as a user and holds an admission ticket linked to the user ID 323a. The admission ticket is not limited to a paper medium and may be in a form of a digital ticket that can be displayed on a smartphone etc., for example.

The camera 21 takes the image of the visitor as the object (a step S201). For example, the camera 21 takes images of the creator visiting the theme park and enjoying the attractions. The camera 21 issues the photograph ID 20a to identify the taking of the image and sends the photograph ID 20a along with the taken image 20b to the ticket issuing device 22 (a step S202).

When receiving the photograph ID 20a and the image 20b from the camera 21 (a step S203), the control unit 201 of the ticket issuing device 22 displays the received image 20b on the display unit 205 (a step S204). The creator sees the displayed image 20b, and if the creator wishes to purchase the image, the creator selects the image 20b to be purchased and executes a purchasing process (a step S205). In the purchasing process, the creator enters the user ID 323a via the input unit 204 of the ticket issuing device 22 and pays the specified charge.

The control unit 201 of the ticket issuing device 22 issues the passcode 20c for the purchased image 20b, which is then stored in the memory unit 202 or the storage 100 making a link with the photograph ID 20a and the image 20b that are received in the step S203, and with the user ID323a entered in the step S205. Also, the control unit 201 of the ticket issuing device 22 sends (uploads) to the server 3 the purchased image 20b along with the photograph ID 20a, the passcode 20c, and the user ID 323a of the creator who purchased the image (a step S207).

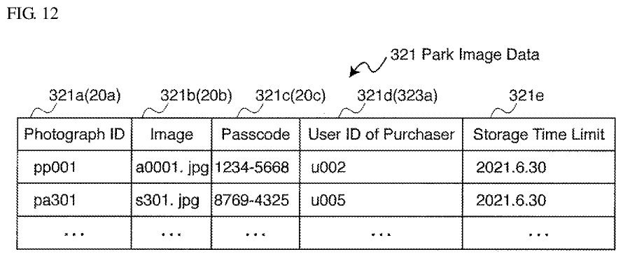

FIG. 12 is a view showing a data configuration of the park image data 321, which is for managing the image 20b (the park image 321b) uploaded to the server 3. The control unit 301 of the server 3 (the park image acquisition unit 31) stores the image 20b uploaded from the photographing system 2 (the ticket issuing device 22) as the park image 321b making a link with a photograph ID 321a (20a), a passcode 321c (20c), a user ID 321d (323a) of the creator who purchased the image, and a storage time limit 321e. For the photograph ID 321a, the same ID as the photograph ID 20a in the photographing system 2 (the ticket issuing device 22) may be used, or a different ID may be given. The park image 321b and the passcode 321c are the same as the image 20b and the passcode 20c of the taken image data 20 in the photographing system 2 (the ticket issuing device 22), respectively. The user ID 321d is the user ID 323a that is entered by the purchaser in the step S205. The storage time limit 321e is stored as a date and time that is calculated based on the predetermined storage time (e.g., for three months after the date of uploading).

Next, the control unit 201 of the ticket issuing device 22 makes the download ticket 82 (the printed matter 8) (a step S208). As mentioned above, the printed matter 8 has the image 20b, which is received in the step S203, being laid out as the sample photo 84. In addition, the printed matter 8 includes the information 85 showing the passcode 20c, which is identification information for downloading the image 20b, the writing 87 that describes downloading procedure of the image 20b, the two-dimensional code 88 including the address information of the server 3, an identification code 89 for checking collation between a half ticket 81 having the sample photo 84 and a half ticket on the side of the download ticket 82, and so on.

The control unit 201 outputs the created download ticket 82 (the printed matter 8) to the printer 206, prints the download ticket 82 on a piece of predetermined paper (a step S209), and lets out the download ticket 82 from a printer outlet (issuing a ticket) (a step S210). A staff hands out to the purchaser of the image 20b the half ticket on the side of the download ticket 82.

Next, a downloading process in which the creator who received the download ticket 82 downloads the image 20b from the server 3 using the creator's terminal 4 will be described.

In the descriptions hereafter, an example in which the creator uses the download ticket 82 shown in FIG. 4 downloads the image 20b that is linked to the photograph ID 20a (‘pp001’) shown in FIG. 3 will be described.

First, the creator starts up the camera 406 of the creator's terminal 4 to read the two-dimensional code 88 on the download ticket 82 (a step S301). The control unit 401 of the creator's terminal 4 displays on the display unit 405 a confirmation screen for checking if the user wishes to access the server 3 directed by the address information (URL) that is read out from the two-dimensional code 88. If the creator accepts an access to the server 3 on the confirmation screen, the control unit 401 makes an access to the server 3 through the communication unit 403 (a step S302).

The server 3 sends to the creator's terminal 4 an input screen for the user to enter the passcode 20c (85) and login information (a step S303). The creator's terminal 4 displays the input screen for the passcode 20c (85) etc. on the display unit 405.

The creator enters on the input screen the login information (the user ID 323a, the password 323d, etc.) and the passcode 20c of the image 20b written on the download ticket 82. The control unit 401 of the creator's terminal 4 sends to the server 3 the entered passcode 20c and the login information (the user ID 323a, the password 323d, etc.) (a step S304).

The server 3 receives the passcode 20c and the login information (the user ID 323a, the password 323d, etc.) and performs an authorization process (a step S305). When properly authorized, the server 3 sends to the creator's terminal 4 the image 20b (321b) corresponding to the passcode 20c (a step S306). The creator's terminal 4 receives the park image 321b sent from the server 3 and displays the park image 321b on the display unit 405 (a step S307). The purchased park image 321b can now be saved in the creator's terminal 4 (a step as308).

The control unit 301 of the server 3 (the image managing unit 39) manages, based on the park image data 321, the storage time limit of the park image 321b stored in the memory unit 302. For example, the control unit 301 of the server 3 deletes from the memory unit 302 the park image 321b whose storage time limit has expired (a step S309).

Also, in the photographing system 2 (the ticket issuing device 22), the image 20b with a certain passed period is deleted from the memory unit 202 or the storage 100 (a step S310). The purchased image 20b stored in the ticket issuing device 22 has been uploaded to the server 3, and it is unnecessary to save the un-purchased image 20b over a long period of time. Thus, the storage time limit of the image 20b in the ticket issuing device 22 may be shorter compared to that of the park image 321b in the server 3.

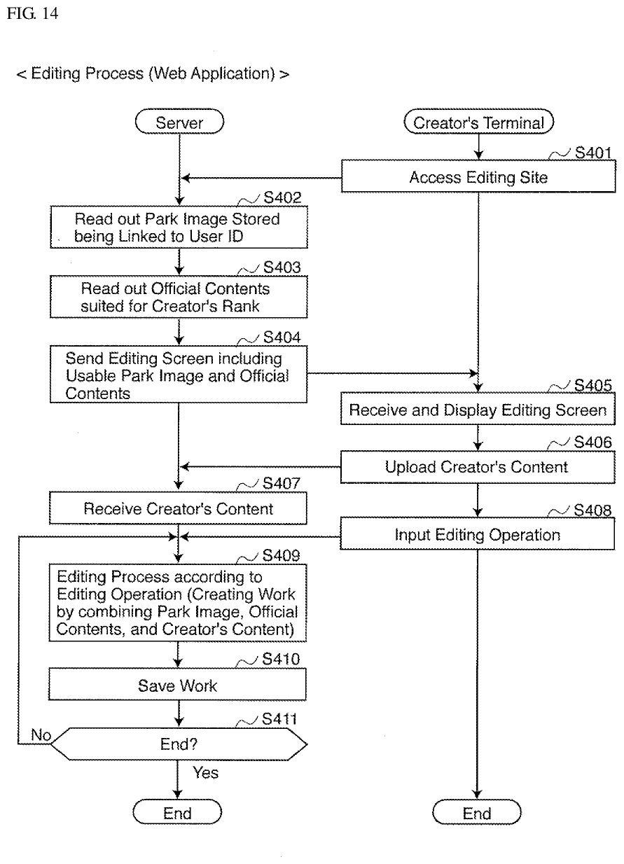

Next, the editing process executed between the server 3 and the creator's terminal 4 will be described referring to FIG. 14. In the first embodiment, the server 3 includes the web application 32 for the creator to edit the work 50 using the park image 321b and the official contents 322b. The creator's terminal 4 accesses through the web browser 41 to an editing site provided by the server 3 so that editing of videos etc. can be performed on the web site (the editing site). The editing site may be reached from a login completion screen, for example.

When the creator's terminal 4 accesses the editing site via the web browser 41 (a step S401), the control unit 301 of the server 3 (the content providing unit 33) refers to the park image data 321 and reads out from the memory unit 302 the park image 321b that is stored being linked to the user ID321d of the creator's terminal 4 (a step S402). Also, the control unit 301 of the server 3 (the content providing unit 33) refers to the creator's rank 323f in the user information 323 of the creator's terminal 4 and reads out from the memory unit 302 the usable official contents 322b according to the rank 323f (a step S403). In the step S403, the usable official contents 322b that are suitable for the date on which the park image 321b is taken, or the official contents 322b that are related to a character or an attraction taken in the park image 321b may be read out.

The control unit 301 of the server 3 (the content providing unit 33 and the editing process unit 34) sends to the creator's terminal 4 the editing screen 70 including the park image 321b and the official contents 322b that are read out in the steps S402 and S403 (a step S404). The creator's terminal 4 displays on the display unit 405 the received editing screen 70 (a step S405, FIG. 16).

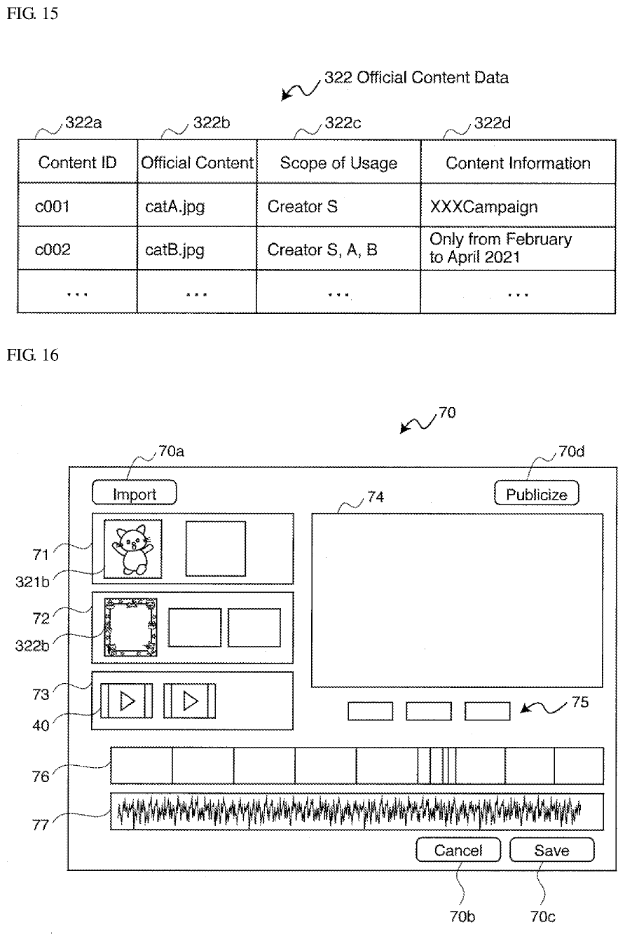

Here, the official content data 322 stored in the server 3 will be described referring to FIG. 15. As shown in FIG. 15, the official content data 322 stores a content ID 322a, a scope of usage 322c, content information 322b, and so on that are linked to each of the official content 322b. The content ID 322a is identification information for the official content 322b. The official content 322b is a material that is to be provided officially by the manger of the photographing system 2 or the server 3, including an image material of the theme park's character or logo, a sound material by a voice actor, and a music material. The scope of usage 322c sets the rank 323f of the user (creator) who can use the official content 322b. The content information 322D sets information and a period of use etc. relating to contents of the official content 322b. For example, “xxx campaign” or a period of usage such as “available only between February and April 2021” may be set. In an example shown in FIG. 15, the official content 322b having the content ID 322a of ‘c001’ and the official content 322b having the content ID 322a of ‘c002’ are provided for the ‘S’ ranked creator, whereas for the ‘A’ ranked creator, the official content 322b having the content ID 322a of ‘c001’ is not provided and only the official content 322b having the content ID 322a of ‘c002’ is provided.

FIG. 16 is a view showing an example of the editing screen 70 provided in the editing site. The editing screen 70 includes a park image library 71 for displaying the usable park image 321b, an official content library 72 for displaying the usable official content 322b, a creator's content library 73 for displaying the creator's content 40 imported from the creator's terminal 4, a preview window 74 for displaying the work 50 in editing, a tool bar 75 for entering various editing operations, timelines 76 and 77 for arranging videos, images, and sounds etc. in time series and so on. An import button 70a that is to be operated at the time of importing the creator's content 40, the new park image 321b, and the official contents 322b, a cancel button 70b to be operated at the time of cancelling the editing, a save button 70c to be operated at the time of saving the work 50 in editing, a publicizing button 70d to be operated at the time of publicizing the work 50, and so on are also provided. The configuration of the editing screen 70 shown in FIG. 16 is a non-limiting example.

The creator operates the import button 70a on the editing screen 70 to import (upload) the creator's content 40 stored in the creator's terminal 4 to the editing screen 70 (a step S406). The control unit 301 of the server 3 displays the imported creator's content 40 on the creator's content library 73 (a step S407). The creator enters editing operations for the work 50 by arranging onto the timelines 76 and 77 the park image 321b, the official content 322b, and the creator's content 40 displayed respectively on the park image library 71, the official content library 72, and the creator's content library 73 of the editing screen 70, and/or by using the tool bar 75 to process or to add effects to the images and sounds (a step S408). The control unit 301 of the server 3 (the editing process unit 34) executes the editing process according to the editing operations entered by the creator's terminal 4 (a step S409). The control unit 301 of the server 3 (the editing process unit 34) displays the work 50 in editing on the preview window 74 and executes playback processes such as play, stop, fast-forward, unwind, etc. according to the operations entered by the creator's terminal 4. When the save button 70c is operated from the creator's terminal 4, the control unit 301 of the server 3 (the editing process unit 34) stores in the memory unit 302 a project file or work data (in a video data form) of the work 50 in editing making a link with the user ID 323a (a step S410). When the cancel button 70b is operated from the creator's terminal 4 (a step S411: Yes), the control unit 301 of the server 3 (the editing process unit 34) closes the editing screen 70 and terminates the editing process (a step S411).

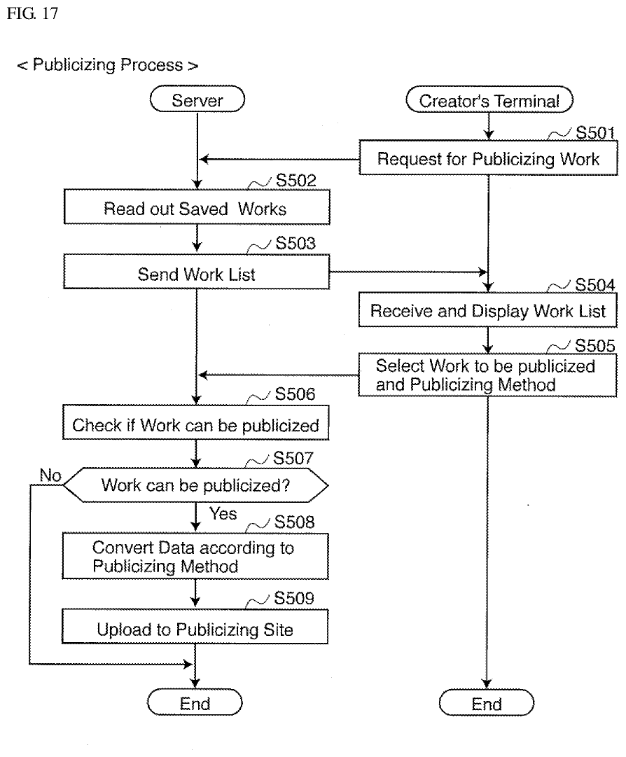

Next, the publicizing process of the work 50 will be described referring to FIG. 17. When the works 50 are completed through the editing process shown in FIG. 14 and the publicizing button 70d is operated from the creator's terminal 4 with the works 50 being stored in the memory unit 302 (a step S501), the control unit 301 of the server 3 (the work publicizing unit 37) reads out from the memory unit 302 the project file or the work data of the works 50 created by the creator (a step S502) and sends a work list of the works 50 to the creator's terminal 4 (a step S503). The creator's terminal 4 displays the received work list (a step S504) and selects the work 50 to be publicized and a publicizing method (a step S505).

The publicizing method can be selected either from a publicizing site provided by the content creation support system 1, SNS, a predetermined video sharing site, or the like. The control unit 401 of the creator's terminal 4 sends the selected work 50 and the publicizing method to the server 3.

The control unit 301 of the server 3 (the checking unit 38) checks whether the work 50 selected by the creator's terminal 4 can be publicized or not (a step S506). For example, the control unit 301 of the server 3 (the checking unit 38) scans the work 50 to examine whether the work 50 properly includes the park image 321b or not, whether the work 50 is appropriate to be publicized or not, or whether the work 50 contains inappropriate contents or not, etc. whereby performing the process of checking if the work 50 can be publicized or not. To simplify the checking process, tags may be embedded into the park image 321b and the official content 322b in advance.

If results of the checking process show that the work 50 cannot be publicized (a step S507: No), the process is terminated. The work 50 cannot be publicized in cases, for example, in which the work 50 does not contain the park image 321b properly, the work 50 is not appropriate to be publicized, or the work 50 contains inappropriate information. On the other hand, if the work 50 can be publicized (a step S507: Yes), the control unit 301 of the server 3 (the work publicizing unit 37) converts the work data into a data format that is appropriate for the publicizing method (a step S508) and sends the work data to the upload destination according to the publicizing method (a step S509). Specifically, if publicizing in the publicizing site provided by the content creation support system 1 is selected, the work 50 is uploaded to the publicizing site of the server 3. If publicizing on SNS or the predetermined video site is selected, the work 50 is uploaded to a server of the SNS or a server of the video site (a step S509). In this way, the work 50 created by the creator is publicized. Since the work 50 contains the park image 321b and the official contents 322b, it is possible to attract attention of viewers of the work 50 to the theme park. Also, since the park image 321b and the official contents 322b can be contained in the work 50 in an officially authorized way, the creator can create the work 50 freely without being anxious about the licensing. Also, the viewers can enjoy an atmosphere of the theme park while watching the work 50 of their favorite creator.

### Second Embodiment

Next, a second embodiment of the present invention will be described. The content creation support system 1 according to the first embodiment of the present invention provides and executes the editing process of the park image 321b and the official contents 322b through the web application 32 (the web site) of the server 3. In the second embodiment, however, a special application is installed on the creator's terminal 4, and the application downloads the park image 321b and the official contents 322b from the server 3 and executes the processes such as editing and uploading (the publicizing process) of the work 50.

Hardware configurations of the photographing system 2, a server 3A, and a creator's terminal 4A of the second embodiment are the same as the photographing system 2 (FIG. 2), the server 3 (FIG. 5), and the creator's terminal 4 (FIG. 6) of the first embodiment, and descriptions will be made by using the same notations for the same parts. Also, an overall configuration of the content creation support system 1 of the second embodiment includes, similarly to the first embodiment (FIG. 1), the photographing system 2 in theme park, the server 3A, and the creator's terminal 4A that are communicatively connected to each other via the network 5.

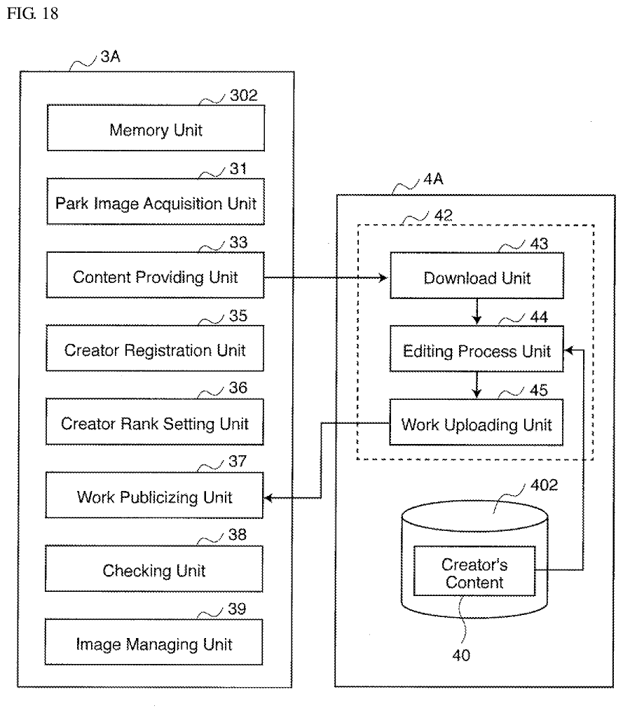

FIG. 18 is a view showing a functional configuration of the server 3A and the creator's terminal 4A in the content creation support system 1 according to the second embodiment. As shown in FIG. 18, the server 3A is provided with the memory unit 302, the park image acquisition unit 31, the content providing unit 33, the creator registration unit 35, the creator's rank setting unit 36, the work publicizing unit 37, the checking unit 38, the image managing unit 39, and so on. The includes an editing application 42, which includes functions of a download unit 43, an editing process unit 44, and a work uploading unit 45. The memory unit 402 of the creator's terminal 4 stores the creator's content 40. The second embodiment is different from the first embodiment in that the creator's terminal 4 includes the editing application 42 having the download unit 43, the editing process unit 44, and the work uploading unit 45, and the server 3 does not have the editing process unit 34.

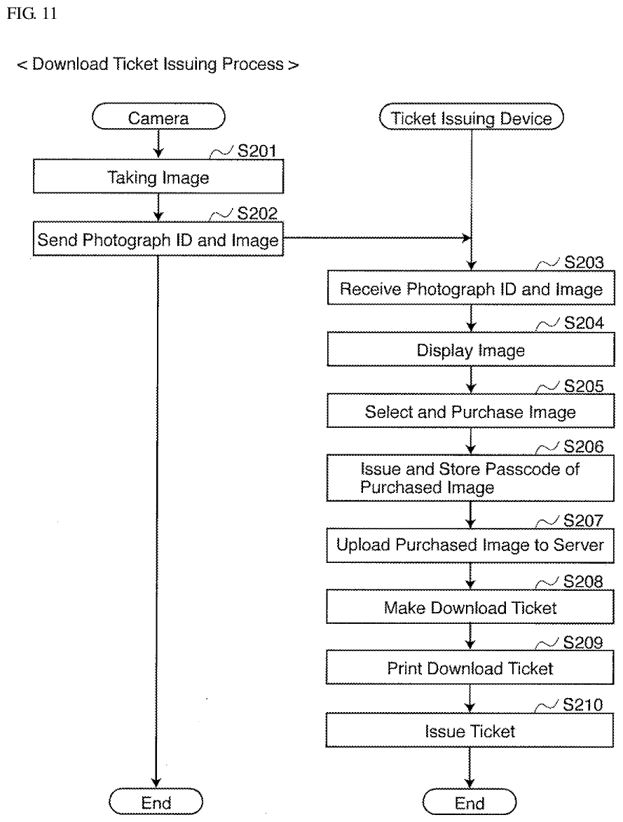

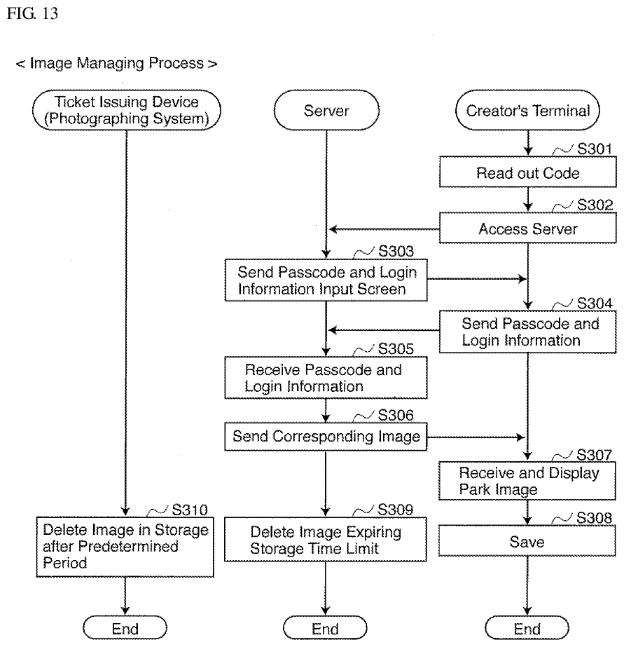

The download ticket issuing process of the photographing system 2 (FIG. 11), the image managing process of the park image 321b in the server 3 (FIG. 13), and the new user registration process (FIG. 9) in the server 3 are the same as in the first embodiment. That is, the creator can purchase the park image 321b (20b) by accessing the server 3 through the web browser 41 and entering the passcode 20c written on the download ticket 82.

The download unit 43 of the creator's terminal 4 accesses the server 3 when the import button 70a is operated on the editing screen 70 (FIG. 16, for example) of the editing application 42, and downloads from the server 3 the park image 321b purchased by the creator and the downloadable official contents 322b. The downloaded park image 321b and the official contents 322b are displayed on the park image library 71 and the official content library 72 of the editing screen 70 of the creator's terminal 4 so as to be edited and stored.

The editing process unit 44 executes the editing process according to the creator's operation on the editing screen 70. Through the editing process, the creator creates the work 50 by combining the park image 321b, the official contents 322b, and the creator's content 40.

The work uploading unit 45 uploads the work 50 created through the editing process unit 44 to the server 3. The server 3 stores the work 50 uploaded from the creator's terminal 4 in the memory unit 302.

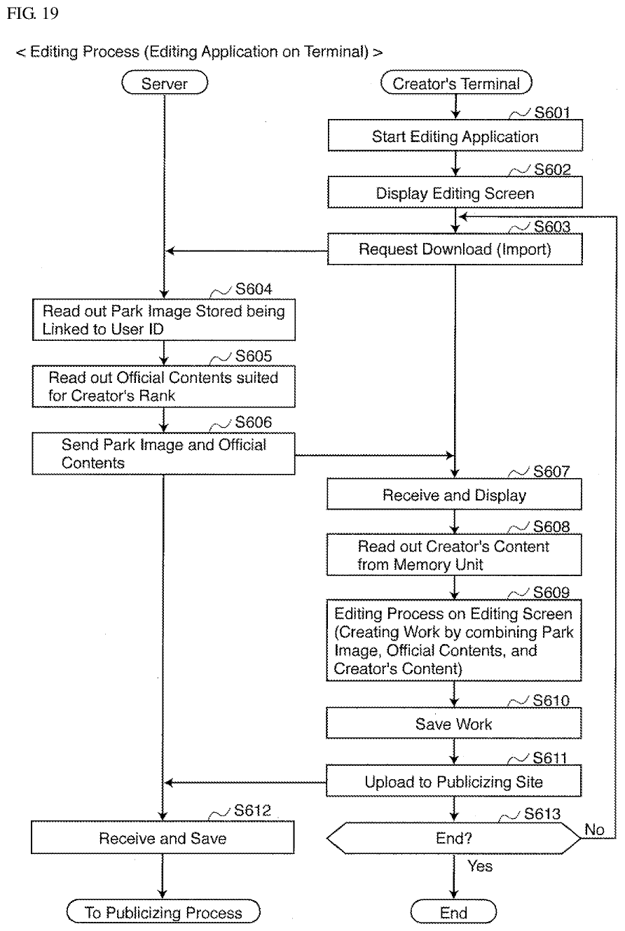

FIG. 19 is a flowchart showing a flow of the editing process in the second embodiment. As shown in FIG. 19, when the creator starts up the editing application 42 on the creator's terminal 4 (a step S601), the control unit 401 of the creator's terminal 4 displays the editing screen 70 shown in FIG. 16, for example, on the display unit 405 (a step S602). When the import button 70a on the editing screen 70 is operated, the control unit 401 of the creator's terminal 4 (the download unit 43) requests the server 3 to download the park image 321b and the official content 322b (a step S603).

The control unit 301 of the server 3 (the content providing unit 33) responds to the request from the creator's terminal 4 by reading out the park image 321b that is stored being linked to the creator's user ID 321d (323a) of the creator (a step S604). Also, the control unit 301 of the server 3 (the content providing unit 33) reads out from the memory unit 302 the usable official contents 322b referring to the creator's rank 323f in the user information 323 of the creator's terminal 4 (a step S605). The control unit 301 of the server 3 (the content providing unit 33) sends to the creator's terminal 4 the park image 321b and the official contents 322b read out in the steps S604 and S605 (a step S606). The creator's terminal 4 (the download unit 43) displays the received park image 321b on the park image library 71 of the editing screen 70, and displays the official contents 322b on the official content library 72 (a step S607).

Also, if the creator selects the creator's content library 73 on the creator's terminal 4 and operates the import button 70a, the creator's content 40 stored in the memory unit 402 of the creator's terminal 4 can be imported into the creator's content library 73 (a step S608).

The creator executes the editing process of the work 50 by arranging onto the timelines 76 and 77 the park image 321b, the official content 322b, and the creator's content 40 displayed respectively on the park image library 71, the official content library 72, and the creator's content library 73 of the editing screen 70, and/or by using the tool bar 75 to process or to add effects to the images. The control unit 401 of the creator's terminal 4 (the editing process unit 44) executes the editing process according to the entered editing operations (a step S609). The control unit 401 of the creator's terminal 4 (the editing process unit 44) displays the work 50 in editing on the preview window 74 and executes playback processes such as play, stop, fast-forward, unwind, etc. according to the operations entered by the creator's terminal 4. When the save button 70c is operated from the creator's terminal 4, the control unit 401 of the creator's terminal 4 (the editing process unit 44) stores in the memory unit 402 a project file or work data in a video or sound data form of the work 50 in editing, making a link with the user ID 323a (a step S610). When the work 50 is completed and the publicizing button 70d is operated, the control unit 401 of the creator's terminal 4 (the work uploading unit 45) reads out the work data of the work 50 from the memory unit 402 and uploads the work data of the work 50 to the server 3 (a step S611). Alternatively, the creator may upload the work 50 to SNS or a video sharing site as the publicizing platform. When receiving the work 50 from the creator's terminal 4, the server 3 stores the work 50 in the memory unit 302 (a step S612) and proceeds to the publicizing process shown in FIG. 17. The publicizing process is the same as in the first embodiment.

When the cancel button 70b is operated from the creator's terminal 4 (a step S613: Yes), the control unit 401 of the creator's terminal 4 closes the editing screen 70 and terminates the editing process.

As described above, in the content creation support system 1 of the second embodiment, the creator can perform downloading of the park image 321b and the official contents 322b, execution of the editing process, and uploading (publicizing) of the work 50 on the creator's terminal 4 by using the editing application 42 installed on the creator's terminal 4. Thus, the editing process of the work 50 can be carried on in an environment without a connection to the network 5.

Although the preferred embodiments of the present invention have been described referring to the attached drawings, the technical scope of the present invention is not limited to the embodiments described above. For example, although the present embodiments are described in the examples where the present invention is applied to photographing services in the theme park etc., the present invention may be applied in various scenes including a sales service of a two-shot photo shoot with a popular character, a photographing sales service at a tourist spot, a photographing sales service at a wedding, a photographing sales service at a school graduation ceremony, and so on. Also, the present invention can be applied to many other services.

Also, although the server 3 uses the download ticket 82 to acquire images from the photographing system 2 in the above-mentioned embodiments, the present invention is not limited thereto. For example, an IC tag storing the user ID 323a may be an admission ticket to the theme park, and the photographing system 2 may acquire the user ID from the IC tag at the time of taking the image, making a link between the image 20b and the user ID 323a. Also, the purchase of the image (settlement process) is not necessarily done after taking the image. Alternatively, the settlement process may be achieved by advance purchase, or sales of an admission ticket attached with an image purchase right.

In addition, it is obvious that persons skilled in the art can think out various examples of changes or modifications within the scope of the technical idea disclosed in the claims, and it will be understood that they naturally belong to the technical scope of the present invention.

### DESCRIPTION OF NOTATIONS

1 . . . content creation support system
2 . . . photographing system
3 . . . server
4 . . . creator's terminal
5 . . . network
8 . . . printed matter
20 . . . taken image data
21 . . . camera
22 . . . ticket issuing device
20b . . . image
20c . . . passcode
31 . . . park image acquisition unit
32 . . . web application
33 . . . content providing unit
34 . . . editing process unit
35 . . . creator registration unit
36 . . . creator's rank setting unit
37 . . . work publicizing unit
38 . . . checking unit
39 . . . image managing unit
40 . . . creator's content
41 . . . web browser
42 . . . editing application
43 . . . download unit
44 . . . editing process unit
45 . . . work uploading unit
50 . . . work
70 . . . editing screen
82 . . . download ticket
100 . . . storage
321 . . . park image data
321b . . . park image
322 . . . official content data
322b . . . official content
323 . . . user information
323a . . . user ID
323f . . . rank

1. A content creation support system comprising:
a photographing system that is provided at a spot and takes an image or a video of a visitor to the spot;
a server that acquires a taken image, which is either the image or the video taken by the photographing system; and
a creator's terminal that is used by a creator and is communicatively connectable to the server via a network, wherein
the server comprises a content providing unit configured to provide, to the creator's terminal, the taken image and an officially prepared official content as editable contents, which are combined with a creator's content created by the creator to create a work.

2. The content creation support system according to claim 1, wherein
the server provides via a web site to the creator's terminal editing means configured to create the work using the taken image, the official content, and the creator's content.

3. The content creation support system according to claim 1, wherein
the content providing unit provides the taken image and the official content to be editable on the creator's terminal; and
the creator's terminal comprises an editing process unit configured to create the work using the taken image, the official content, and the creator's content.

4. The content creation support system according to claim 1, wherein
the server further comprises a registration unit configured to register the creator; and
the content providing unit provides the taken image and the official content only to the creator who has been registered by the registration unit.

5. The content creation support system according to claim 4, further comprising:
a setting unit configured to set a rank of the creator, wherein
the usable official content provided by the content providing unit differs depending on the rank of the creator set by the setting unit.

6. The content creation support system according to claim 1, wherein
the content providing unit provides the official content that are suitable for the provided taken image.

7. The content creation support system according to claim 1, wherein
the server further comprises a publicizing unit configured to publicize the work.

8. The content creation support system according to claim 7, wherein
the server further comprises a checking unit configured to check whether the work can be publicized or not; and
the publicizing unit publicizes the work when the checking unit decides that the work can be publicized.

9. The content creation support system according to claim 1, wherein
the server further comprises an image managing unit configured to acquire the purchased taken image from the photographing system and to manage use for the work and storage time of the taken image.

10. A server comprising:
an image acquisition unit configured to acquire a taken image, which is either an image or a video, taken by a photographing system, which is provided at a spot and takes the taken image of a visitor to the spot;
a communication unit configured to communicatively connect via a network to a creator's terminal, which is a terminal used by a creator; and
a content providing unit configured to provide to the creator's terminal the taken image and an officially prepared official content as editable contents, which are combined with a creator's content created by the creator to create a work.

11. A terminal that is communicatively connectable via a network to a server for acquiring a taken image, which is either an image or a video, taken by a photographing system that is provided at a spot and takes the taken image of a visitor to the spot, the terminal comprising:
a download unit configured to download from the server the taken image and an officially prepared official content; and
an editing process unit configured to edit and create a work by combining the downloaded taken image and the official content with creator's content, which is a content created by a creator.

12. A method for supporting content creation, the method comprising:
taking an image or a video by a photographing system that is provided at a spot and takes images of visitors to the spot;
acquiring through a server a taken image, which is either the image or the video taken by the photographing system;
providing through the server the editable taken image and officially prepared official content to a terminal that is communicatively connected via a network to the server; and
editing a work by a creator using the terminal and combining the taken image and the official content with creator's content, which is a content created by the creator.

13. A storage medium that stores a program, wherein the program causes a computer to function as:
an image acquisition unit configured to acquire a taken image, which is either an image or a video, taken by a photographing system that is provided at a spot and takes images of visitors to the spot;
a communication unit configured to communicatively connect via a network to a creator's terminal, which is a terminal used by a creator; and
a content providing unit configured to provide to the creator's terminal the taken image and an officially prepared official content as editable contents, which are combined with a creator's content created by the creator to create a work.

14. A storage medium that stores a program, wherein the program causes a computer, which is communicatively connectable via a network to a server, to function as:
a download unit configured to download from the server a taken image, which is either an image or a video, taken by a photographing system that is provided at a spot and takes images of visitors to the spot and an officially prepared official content; and
an editing process unit configured to edit and create a work by combining the downloaded taken image and the official content with creator's content, which is a content created by a creator.

15. The content creation support system according to claim 2, wherein
the server further comprises a registration unit configured to register the creator; and
the content providing unit provides the taken image and the official content only to the creator who has been registered by the registration unit.

16. The content creation support system according to claim 3, wherein
the server further comprises a registration unit configured to register the creator; and
the content providing unit provides the taken image and the official content only to the creator who has been registered by the registration unit.
